(19) United States
(12) Patent Application Publication
(10) Pub. No.: US 2015/0100501 A1
(43) Pub. Date: Apr. 9, 2015

(54) SYSTEM AND METHOD TO PROVIDE COLLABORATION TAGGING FOR VERIFICATION AND VIRAL ADOPTION

(71) Applicant: Shocase, Inc., San Francisco, CA (US)

(72) Inventor: Ronald P. Young, Mill Valley, CA (US)

(21) Appl. No.: 14/507,003

(22) Filed: Oct. 6, 2014

Related U.S. Application Data
(60) Provisional application No. 61/887,423, filed on Oct. 6, 2013.

(51) Int. Cl. G06Q 10/10; G06Q 50/00

(52) U.S. Cl. CPC G06Q 10/101; G06Q 50/01
USPC 705/300

(57) ABSTRACT

A verticalized collaborative network system for eliciting collaborative participation for a project that includes a communications module to establish communications with verified collaborators and candidate collaborators, a collaborative tagging module to process project and candidate collaborator information identifying potential participants corresponding to the project and their respective contact information, and one or more storage devices configured to store attributes of the project and contact information. The system being configured such that in response to receiving details of the project and candidate collaborator information, the collaborative tagging module processes the received project and candidate collaborator information to identify and store attributes of the project, and generates a notifying communication to the potential participants including a message notifying each of the potential participants of recognition relative to the project and invites each of the potential participants to register as members of the verticalized collaborative network system.

### CROSS-REFERENCE TO RELATED APPLICATIONS

This application claims priority to U.S. Provisional Patent Appln. Ser. No. 61/887,423, filed Oct. 6, 2013 entitled, “A System and Method To Provide Collaboration Tagging For Viral Verification and Adoption.”

### FIELD OF THE INVENTION

The invention generally relates to a collaborative networking site platform and, more particularly to, collaborative tagging for viral identification and adoption within a collaborative networking site.

### BACKGROUND OF THE INVENTION

Given their immense popularity, social networking websites have spawned in prodigious numbers across the globe. The attraction of these websites rests squarely on their ability to enable users to socially interact with other users by facilitating the sharing of user-generated content, such as, blogs, images, videos, messages, etc. Typically, users simply sign up with the social networking website by providing certain user credential information and the computer server that hosts the website provides access thereto as well as stores user-submitted content.

While conventional social networking websites present appealing forums for social interaction, the vast information and content they contain may be too unstructured and unmanageable to provide any meaningful interpretation. In so doing, such social websites lack the framework to support collaboration efforts between like-minded users regarding specific projects or activities.

### SUMMARY OF THE INVENTION

The invention, as disclosed herein, addresses the deficiencies and drawbacks noted above by providing systems and methods that are directed to a vertical collaborative network having a subject-based platform configured to support collaborative efforts between and amongst like-minded users with regard to specified activities, projects, undertakings, ventures, etc.

The disclosed system may embody a A verticalized collaborative network system for eliciting collaborative participation for a project, the system comprising: a communications module executed by one or more physical processors programmed with computer program instructions to establish communications with verified collaborators and candidate collaborators; a collaborative tagging module executed by the one or more physical processors programmed with computer program instructions to process project and candidate collaborator information identifying potential participants corresponding to the project and their respective contact information; and one or more storage devices configured to store attributes of the project and contact information, wherein, in response to receiving details of the project and candidate collaborator information, via the communication module, the collaborative tagging module: processes the received project and candidate collaborator information to identify and store attributes of the project and contact information in the one or more storage devices, and generates a notifying communication to the potential participants, the notifying communication including a message notifying each of the potential participants of recognition relative to the project, inviting each of the potential participants to register as members of the verticalized collaborative network system, and providing an imbedded communication link for response to the invitations.

Moreover, the disclosed method may embody a computer-implemented method of eliciting collaborative participation for a project within a verticalized collaborative network system, the method being implemented by the network system having one or more physical processors programmed with computer program instructions that, when executed by the one or more physical processors, cause the network system to perform the method, the method comprising: electronically receiving project information indicating details of the project and candidate collaborator information identifying potential participants corresponding to the project and their respective contact information, the project and candidate collaborator information provided by a verified collaborator of the verticalized collaborative network system; processing the received project and candidate collaborator information to respectively store attributes of the project and contact information; processing the attributes of the project and candidate collaborator information to generate a notifying communication to the potential participants, the notifying communication including a message notifying each of the potential participants of recognition relative to the project, inviting each of the potential participants to register as members of the verticalized collaborative network system, and providing an imbedded communication link for response to the invitations; and electronically transmitting the notifying communication to each of the potential participants in accordance with their respectively stored contact information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 depicts a general overview of a vertical collaborative networking system, in accordance with various aspects of the present disclosure.

FIG. 2 depicts a flow chart of the posting process for projects and collaborators to the vertical collaborative networking system, in accordance with various aspects of the present disclosure.

FIG. 3 depicts a listing of one or more of projects posted in the vertical collaborative networking system, in accordance with various aspects of the present disclosure.

FIG. 4 depicts a listing of collaborators that may participate in the one or more of projects posted in the vertical collaborative networking system, in accordance with various aspects of the present disclosure.

FIG. 5 depicts an exemplary project posted on the vertical collaborative networking system and the collaborators associated with the project, in accordance with various aspects of the present disclosure.

FIG. 6 depicts how a collaborator associated with the project may also be associated with a second posted project, in accordance with various aspects of the present disclosure.

### DETAILED DESCRIPTION OF THE INVENTION

In the following description, for the purposes of explanation, numerous specific details are set forth in order to provide a thorough understanding of the implementations of the invention. It will be appreciated, however, by those having skill in the art that the implementations of the invention may be practiced without these specific details or with an equivalent arrangement. In other instances, well-known structures and devices are shown in block diagram form in order to avoid unnecessarily obscuring the implementations of the invention.

As will be apparent by the ensuing description and illustrations, the vertical collaborative network platform may be embodied as an Internet website or any combination of hardware and software configured to facilitate and support collaborative efforts between and amongst participants (e.g., collaborators) of the platform relative to posted activities (e.g., projects). In certain embodiments, the one or more projects may be posted in whole or in part to the system.

Moreover, the vertical collaborative network platform enables and encourages the designation and enrollment of participants (e.g., collaborators) to verify posted project details and to grow the system membership by incentivizing non-members, through special recognition, to verify system data and recognize other members and non-members.

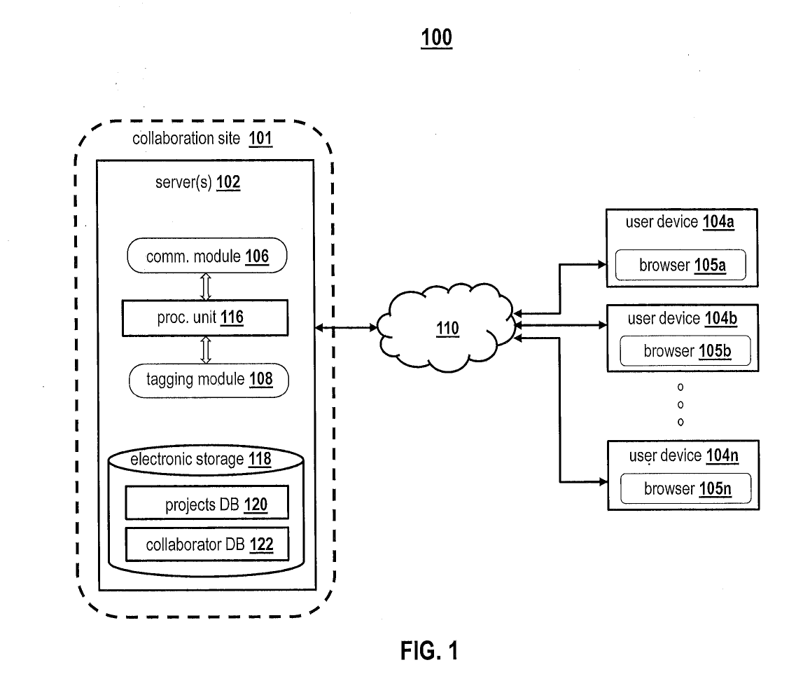

With this said, FIG. 1 depicts a general overview of vertical collaborative networking system 100, in accordance with various aspects of the present disclosure. Vertical collaborative networking system 100 is directed to a subject-based platform configured to support collaborative efforts between and amongst like-minded users with regard to specified activities, projects, undertakings, ventures, etc. In other words, vertical collaborative networking system 100 provides a verticalized framework that is project-centric and/or activity-centric to focus the communication, verification, and collaboration between interested users regarding the subject matter of a specific project and/or activity while effectively screening those interested users from unnecessary communications or irrelevant information that may arise from unrelated projects/activities.

For example, in marketing, a verticalized framework may include activities/projects such as, radio commercials, television commercials, print ads, theme songs, product rollouts, special effects, targeting efforts, etc. In entertainment, a verticalized framework may include activities/projects such as plays, musicals, performances, movies, short stories, books, poems, sideshows or mimes, etc. In sports, a verticalized framework may include activities/projects such as games, championships, regattas, Olympic events, matches, races, or bouts. It will be appreciated that in each of these activities/projects, there are leaders and members, directors and actors, writers and editors, coaches and players, producers and authors, etc. and every one is a collaborator have associated with other collaborators to achieve a specific goal within a respective activity or project. It should also be appreciated that candidate collaborators specifically interested in information regarding “musical production” projects would not be interested in information that is irrelevant to such projects, such as NFL wins and awards or NASCAR race results or standings.

In one embodiment, vertical collaborative networking system 100 includes collaborative networking website 101 that is hosted by server 102 (or servers 102) to facilitate and support collaborative efforts between and amongst participants (e.g., collaborators) of the platform for specified projects and/or activities. As noted above, such projects/activities may include, but are not limited to, work projects, leisure activities, performances, sports, games, sales, strategies, and any endeavor in which collaborators may jointly contribute within a verticalized framework.

Server(s) 102 may embody one or more computing devices incorporating hardware components, operating systems, and programming languages that may be familiar to those skilled in the art in order to implement the processing as described herein. The computing devices may be a general-purpose computer or a special purpose computer. The computing devices may include one or more memory storage devices, such as, electronic storage device(s) 118 as well as one or more physical processing units 116 programmed with one or more computer program instructions to perform the functionality of system 100, in addition to other components. The computing devices may also include communication facilities to enable the exchange of information with a network or other computing platforms. The computing devices may further include a plurality of hardware, software, and/or firmware components operating together to provide the functionality attributed herein to server(s) 102. For example, the computing devices may be implemented by a cloud of computing platforms operating together as the computing devices.

As noted above, server(s) 102 may include memory storage devices, such as, electronic storage device(s) 118, which may take the form of non-transitory storage media that electronically stores information. The electronic storage media of the electronic storages may include one or both of system storage that is provided integrally (e.g., substantially non-removable) with the servers or removable storage that is removably connectable to the servers via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources).

The electronic storage may also store software algorithms, information determined by the processors, information received from server(s) 102, information received from other computing platforms, or other information that enables the servers to function as described herein. In particular, with regard to system 100, electronic storage device(s) 118 may be configured to store information related to activities or projects and associated content thereof in projects database (DB) 120 as well as store information related to participating users of system 100, such as collaborating members (i.e., collaborators) in collaborator database (DB) 122. The databases 120, 122 may include, or interface with, for example, an Oracle™ relational database, Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

As also noted above, server(s) 102 may include processing unit 116 (or units) that are programmed to provide information processing capabilities in server(s) 102. As such, processing unit(s) 116 may include one or more of a digital processor, analog processor, digital circuit designed to process information, analog circuit designed to process information, a state machine, and/or other mechanisms for electronically processing information. In some implementations, processing unit(s) 116 may include a plurality of processors that are physically located within the same computing device or may represent processing functionality of a plurality of devices operating in coordination. Regardless of physical representation, processing unit(s) 116 may be programmed to execute computer program instructions to perform the functionality of communication module 106 and collaborative tagging module 108, as well as other components.

Along these lines, it should be appreciated that the description of the functionality provided by modules 106, 108 described heretofore is for illustrative purposes, and is not intended to be limiting, as module modules 106, 108 may provide more or less functionality than is described. For example, additional modules may be programmed to perform some or all of the functionality attributed herein to modules 106, 108.

To this end, communication module 106 may be configured to enable server(s) 102 to communicate with user devices 104a-104n via network 110. Such communications may take different forms, such as request-reply web browser communications, electronic mail (e-mail), instant messaging (IM), short messaging service (SMS), etc. in accordance with standardized protocols and specifications.

The collaborative tagging module 108 of server(s) 102 may be configured to identify (i.e., tag) individuals, who may be members or non-members, that have contributed, worked, provided input, and/or have a relationship to a posted project/activity as well as generate invitations/notifications to such individuals, via communication module 106, to join vertical collaborative networking system 100. In addition, collaborative tagging module 108 may be configured to verify which invited individuals have become registered collaborators.

As alluded to above, based on the disclosed architecture, server(s) 102 may communicate with one or more user devices 104a-104n via network 110. Network 110 may include any one or more of telecommunication network platforms, such as, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. The network(s) may be a single network or a combination of different networks. For example, the network(s) may be a local area network (LAN), a wide area network (WAN), a public network, a private network, a proprietary network, a Public Telephone Switched Network (PSTN), the Internet, a wireless network, a virtual network, or any combination thereof. The network(s) may also include various network access points, e.g., wired or wireless access points such as base stations or Internet exchange points through which a data source may connect to the network(s) in order to transmit/receive information via the network(s).

It will be appreciated that user devices 104a-104n are configured to receive data from, and transmit data to, server(s) 102 via network 110 as well as process any related data. User devices 104a-104n may take the form of personal computers, personal digital assistants, iPads, desktop computers, mobile phones, tablet computers, laptop computers, smartphones, gaming devices, networking devices, navigation devices, wearable computing devices, communication-enabled appliances, etc. Moreover, user devices 104a-104n may be configured with web browser capabilities 105a-105n to enable connection to, as well as facilitate the data transfer to/from, collaborative networking website 101 hosted by server(s) 102.

By way of illustration, collaborators that have registered with vertical collaborative networking system 100 may correct posted project/activity content to certify its correctness, or submit or post new project/activity content to system 100 by initially communicating with, and accessing, collaborative networking website 101. Such access may be achieved by entering the Uniform Resource Locator (“URL”) address of website 101 in web browser 105a-105n of the verified collaborator's respective user devices 104a-104n. In turn, communication module 106 of server(s) 102 respond to the access requests of web browsers 105a-105n with instructions and scripts, compliant with standardized protocols (e.g., HyperText Markup Language (“HTML”)), that enable web browsers 105a-105n to display input query information and appropriately interact with server(s) 102. In some embodiments, such communication transactions may include displaying collaborator username and password information and, upon confirmation of valid information, causing web browsers 105a-105n to display website pages/instructions for submitting or posting project/activity content.

Vertical collaborative networking system 100 may preferably be configured to engage and invite unregistered (candidate) collaborators to register and participate in posted projects/activities. In some embodiments, candidate collaborators may receive a communication (e.g., e-mail, text message, etc.) generated by collaborative networking website 101 that notifies candidate collaborators of recognition, referrals, and/or recommendations initiated by registered collaborators regarding specific projects/activities posted on vertical collaborative networking system 100. The communication may also include imbedded link information (e.g., URL) that is displayed on the web browsers 105a-105n of the candidate collaborators' respective user devices 104a-104n. Upon actuation of the imbedded link information (e.g., by clicking or other means), web browsers 105a-105n are directed to collaborative networking website 101 in which communication module 106 of server(s) 102 present registration/membership information to the web browsers 105a-105n of candidate collaborators.

It should be appreciated that the instructions of communication module 106 of server(s) 102 may include actuating web browsers 105a-105n to display input screens, dialog boxes, icons, graphics, etc. requesting entry of authenticating credentials from the candidate collaborators that uniquely identify the collaborators to officially register the collaborators. Such authenticating credentials may include, for example, user names and passwords. In addition, web browsers 105a-105n may be actuated to additionally request relevant collaborator information, such as, for example, name, contact data, e-mail address, phone numbers, occupation, qualifications, expertise, experience, education, past project data, etc. This collaborator information is subsequently stored in collaborator database (DB) 122 of server(s) 102 and used by vertical collaborative networking system 100 to authenticate and verify registered collaborators as well as accept, share, and post information from contributed by the registered collaborators. That is, once it is determined that a collaborator is registered, collaborative networking website 101 enables the registered collaborator to communicate with other registered collaborators as well as post/create/establish/publish a project which may interest or involve other registered collaborators.

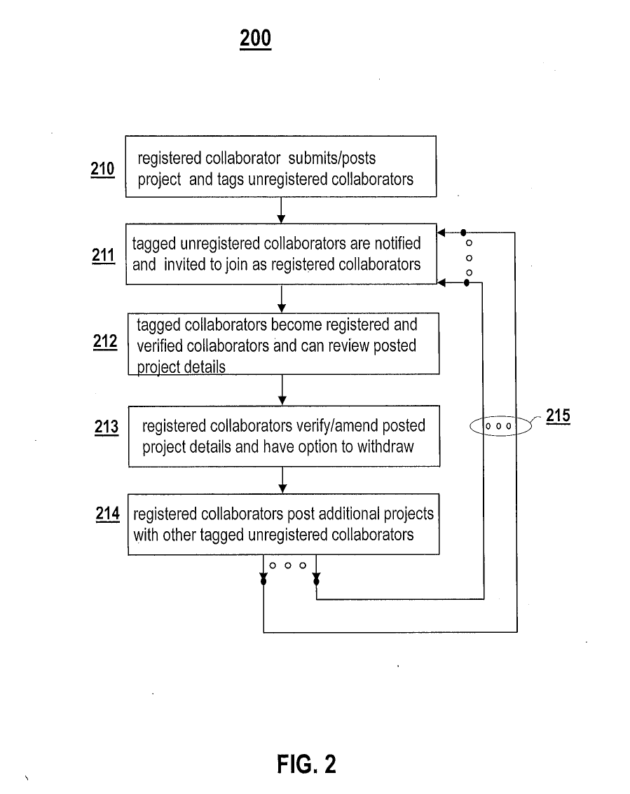

Attention will now be turned to a more detailed description of the operation of various aspects of vertical collaborative networking system 100 and collaborative networking website 101. In particular, FIG. 2 depicts a general flow chart diagram of the project posting and collaborator engagement process 200, in accordance with various aspects of the present disclosure. As shown at block 210, a registered collaborator submits project/activity content, by way of posting, creating, and/or publishing, to collaborative networking website 101. In some embodiments, the submission of the project/activity content may, for example, be through known means such as accessing collaborative networking website 101 from the web browser 105a-105n of their respective user devices 104a-104n. The description and detailed information of the posted project may be stored in projects database (DB) 120 of server(s) 102 and remains in an unverified state until one or more collaborators confirm the details of the posted project content.

Along with the posted project content, the registered collaborator may also identify or “tag” collaborating individuals that have contributed, worked, provided input, and/or have a relationship to the posted project or similar projects. In some embodiments, the registered collaborator submits candidate collaborator contact information, such as, name, e-mail address, phone numbers, social network provider usernames/IDs, etc. which is received by collaborative tagging module 108 for processing and may be stored in collaborator database (DB) 122 of server(s) 102. Accordingly, at block 211, collaborative tagging module 108, in combination with the tagged collaborator contact information stored in collaborator database (DB) 122 and communication module 106, notifies the tagged collaborators that their accomplishments relative to the posted project content have been recognized on system 100. Such notifications may be communicated to the tagged collaborators via their respective user devices 104a-104n in any one of a variety of communication techniques consistent with their stored tagged information, such as, for example, email messaging, text messaging, etc.

In addition, the notifications may also extend invitations to the tagged collaborators to join as a registered collaborator of system 100 in order to gain access to and review/confirm the posted project content. In some embodiments, the notifications may include an imbedded link, such as a Uniform Resource Locator (URL) or other communication linking construct, that is directed to collaboration site 101.

At block 212, upon clicking the imbedded link, web browsers 105a-105n of the tagged collaborators are directed to collaboration site 101 in which communication module 106 of server(s) 102 actuate web browsers 105a-105n to display input screen(s) (e.g., dialog boxes, icons, graphics, etc.) that request entry of collaborator information (e.g., usernames, passwords, etc.) to officially register with system 100. Moreover, as registered collaborators, they may review details of the posted project, as stored by projects database (DB) 120, and verify, revise, correct, and/or amend the project details at block 213. Once the posted projected has been verified by one or more collaborators, the project content may be designated as being in a verified state. Furthermore, as registered collaborators, system 100 provides them with the option to withdraw their association with the project as well as the opportunity to view other previously posted projects, or post new projects of their own.

At block 214, system 100 enables the registered collaborators of the first posted project to submit their own project content along with additional tagged collaborators which, in turn, enables those tagged collaborators to be notified, register, verify/amend, and post their own additional projects. It should be appreciated that collaborators may be invited, added, associated, recognized, and/or attributed to more than one project, via one or multiple unique identifiers, such as, email addresses, phone numbers, user names, etc. This virtuous circle of engagement iteratively leads to a viral expansion of posted project content and registered collaborators, as shown by indicator 215. This virtuous circle of engagement iteratively leads to a viral expansion of posted project content and registered collaborators, as shown by indicator 215.

Equally notable, when each collaborator signs in and corrects/verifies details of the project content and other collaborators, system 100 organically builds a larger repository of verified data that becomes uniquely more valuable to all collaborators within the vertical framework. Furthermore, the network effect based on the increasing numbers of collaborators may be accelerated by the benefits conferred by system 100, such as recognition, rewards, etc. As a result, vertical collaborative networking system 100 has the capability to become a growing and comprehensive site with collaborators eager to join system 100 as the projects posted on site 101 displays the work to the public with increasing commercial benefits by way of essentially cost-free exposure and advertising.

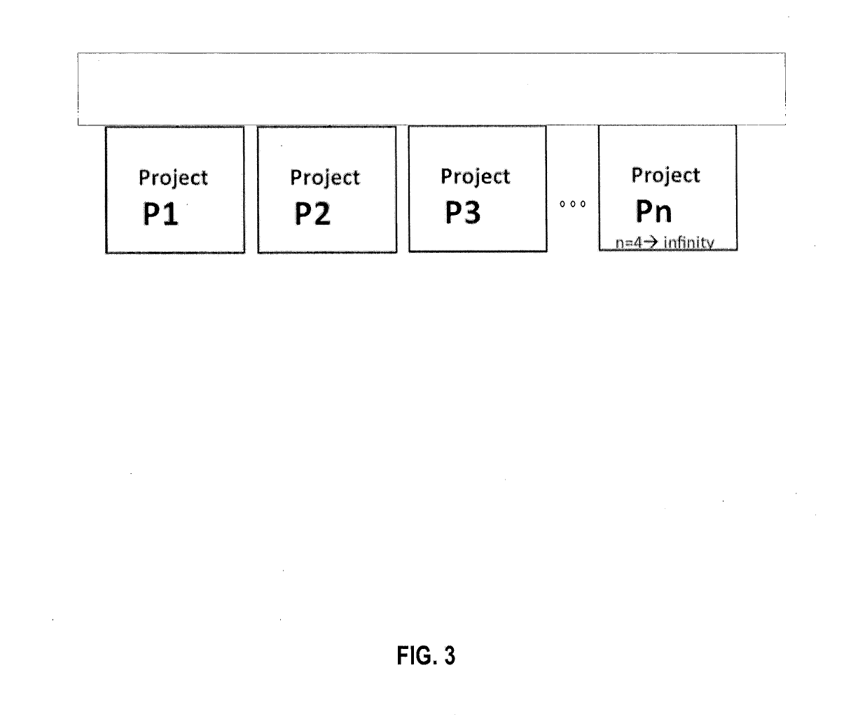

FIG. 3 depicts projects P1-Pn in accordance with vertical collaborative networking system 100, where projects P1-P3 are followed by future additional projects, i.e. project Pn, n=4→∞. As noted above, projects P1-Pn may be activities in any one of a myriad of areas of interest, e.g. architecture, mathematics, biology, medicine, construction, sports, marketing, movies, etc. As such, the administrators of system 100 may, should circumstances deem necessary, limit a designated project or activity to a predetermined subject matter area.

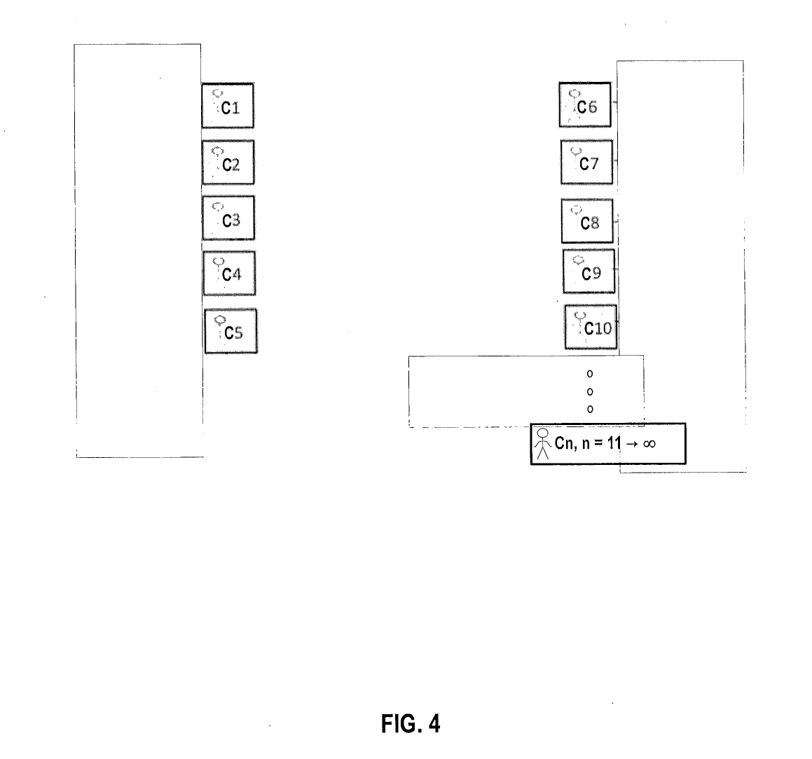

FIG. 4 illustrates a set of candidate collaborators C1-Cm in accordance with vertical collaborative networking system 100, where collaborators C1-C10 are followed by additional collaborators, i.e. collaborators Cm, m=4→∞. Each of collaborators C1-Cm may be a part of, belong to, or be a member of any one or all of projects P1-Pn. Specific examples shown in FIG. 3 are for collaborators C1-10 designated respectively by lead line numbers 31-39 in addition to Collaborator 10 designated by lead line number 310; also the generic lead line 31n where n runs from 11→infinity, making it possible to have essentially an unlimited number of Projects and Collaborators.

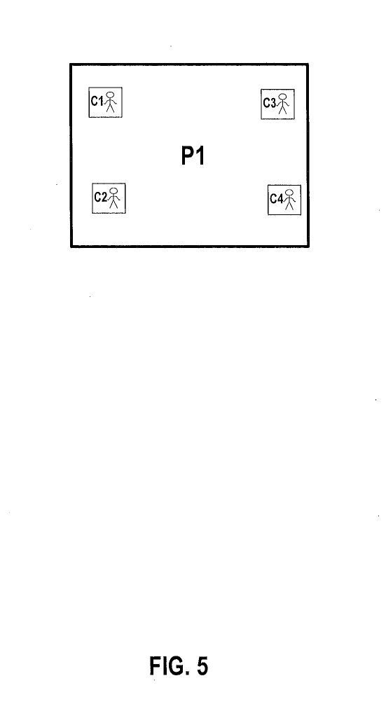

FIG. 5 illustrates a single project P1 in accordance with vertical collaborative networking system 100, with four registered collaborators C1-C4 that are related to project P1 because at least one of the four collaborators C1-C4 has posted project P1 on collaborative networking website 101 describing the project and specifying how each of the individuals collaborated and contributed to posted project P1. All four collaborators C1-C4 accepted the invitation to register to website 101 and are thus termed collaborators for project P1. Much of the posted data on website 101 is freely accessed by the public, where the posting of project data by one or more registered collaborators organically confers a reward on the other collaborators through public recognition of their role and success in completing project P1.

Any one of collaborators C1-C4 who is registered on collaborative networking website 101 has the right to post such data. By specifying a confidential email address for each of the Collaborators, system 100 operating website 101 can notify each collaborator that they have been recognized for their achievement. Because the first registered collaborator who has posted the project data has been altruistic in giving recognition to fellow collaborators, the fellow collaborators are thus incentivized and encouraged to investigate the nature of their reward by seeking greater understanding of the data available on system 100. To this end, website 101 may be configured to notify such collaborators that registration will grant them the opportunity to post additional data. As such, a collaborator, having been encouraged by the aforementioned reward of recognition, is thus motivated to seek additional rewards, and to altruistically reward others, through the registration and posting of additional projects.

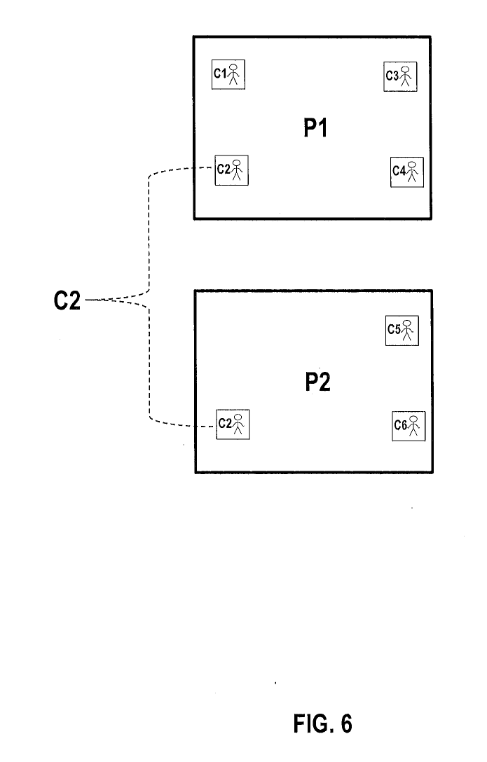

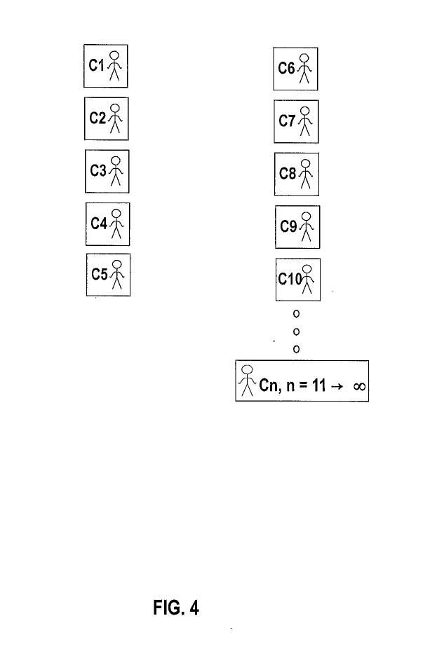

FIG. 6 further illustrates the viral growth and expansion of vertical collaborative networking system 100 by way of original project P1 and additional project P2. As shown, project P1 is associated with four registered collaborators C1-C4 while project P2 is associated with three registered collaborators C2, C5, and C6. The growth of the projects is evidenced by the fact that collaborator C2 is a collaborator for both projects P1 and P2. The second project P2 with its collaborators comes about by virtue of collaborator C2, as one of the collaborators in P1, having an interest in furthering his own recognition as well as desiring to extend recognition to other collaborators with whom he is familiar. Thus, collaborator C2 operates as the seminal collaborator giving rise to the viral growth of collaborators and projects that is facilitated and organically supported by vertical collaborative networking system 100, in which recognition as a collaborator on the first project P1 incentivizes him to post additional projects that; in turn, confers recognition and rewards to additional collaborators to continually expand the number of registered collaborators and projects.

Thus, as described above, by virtue of the collaborative tagging module, collaborative networking system is configured to provide a platform that organically and virally expands information and content for specific subject matter within a vertical framework. Such a platform provides a unique structure in which information and content regarding specific projects/activities and related information and content are made manageable to interested parties (i.e., collaborators) and encourages/supports engagement in such projects/activities through recognition.

Other implementations, uses and advantages of the invention will be apparent to those skilled in the art from consideration of the specification and practice of the invention disclosed herein. The specification should be considered exemplary only, and the scope of the invention is accordingly intended to be limited only by the following claims.

1. A computer-implemented method for collaborative participation of a project within a verticalized collaborative network system, the method being implemented by the network system having one or more physical processors programmed with computer program instructions that, when executed by the one or more physical processors, cause the network system to perform the method, the method comprising:
electronically receiving project information indicating details of the project and candidate collaborator information identifying potential participants corresponding to the project and their respective contact information, the project and candidate collaborator information provided by a verified collaborator of the verticalized collaborative network system;
processing the received project and candidate collaborator information to respectively store attributes of the project and contact information;
processing the attributes of the project and candidate collaborator information to generate a notifying communication to the potential participants, the notifying communication including a message notifying each of the potential participants of recognition relative to the project, inviting each of the potential participants to register as members of the verticalized collaborative network system, and providing an imbedded communication link for response to the invitations; and
electronically transmitting the notifying communication to each of the potential participants in accordance with their respectively stored contact information.

2. The computer-implemented method of claim 1, further comprising that, in response to actuation of the imbedded communication link by the potential participants, the verticalized collaborative network system presents the potential participants with credential requests and, upon valid entry of the credential requests, the verticalized collaborative network system verifies and establishes the potential participants as registered members enabling access to review, verify, and revise the attributes of the project and opportunities to withdraw from participation of the project.

3. The computer-implemented method of claim 1, wherein the notifying communication includes reward and/or recognition information to potential participants.

4. The computer-implemented method of claim 3, wherein the eliciting of collaborative participation iteratively leads to a viral expansion of verticalized, relevant project content and registered members.

5. The computer-implemented method of claim 1, wherein the electronically receiving of project information and candidate collaborator information is conducted through a website.

6. The computer-implemented method of claim 5, wherein the project information and candidate collaborator information is submitted to the website from member devices.

7. The computer-implemented method of claim 1, wherein the attributes of the project are stored in a project database and candidate collaborator information is stored in a collaborator database.

8. The computer-implemented method of claim 1, wherein the notifying communication comprises email messaging and/or text messaging.

9. The computer-implemented method of claim 5, wherein the imbedded communication link comprises an address of the website.

10. The computer-implemented method of claim 1, wherein the verticalized collaborative network system is configured to be project-centric to focus on processing of related project subject matter and interested collaborators.

11. A verticalized collaborative network system for collaborative participation of a project, the system comprising:
a communications module executed by one or more physical processors programmed with computer program instructions to establish communications with verified collaborators and candidate collaborators;
a collaborative tagging module executed by the one or more physical processors programmed with computer program instructions to process project and candidate collaborator information identifying potential participants corresponding to the project and their respective contact information; and
one or more storage devices configured to store attributes of the project and contact information,
wherein, in response to receiving details of the project and candidate collaborator information, via the communication module, the collaborative tagging module:
processes the received project and candidate collaborator information to identify and store attributes of the project and contact information in the one or more storage devices, and
generates a notifying communication to the potential participants, the notifying communication including a message notifying each of the potential participants of recognition relative to the project, inviting each of the potential participants to register as members of the verticalized collaborative network system, and providing an imbedded communication link for response to the invitations.

12. The system of claim 11 wherein, in response to actuation of the imbedded communication link received by the potential participants, the verticalized collaborative network system presents the potential participants with credential requests and, upon valid entry of the credential requests, the verticalized collaborative network system verifies and establishes the potential participants as registered collaborators enabling access to review, verify, and revise the attributes of the project and opportunities to withdraw from participation of the project.

13. The system of claim 11, wherein the notifying communication includes reward and/or recognition information to potential participants.

14. The system of claim 13, wherein the eliciting of collaborative participation iteratively leads to a viral expansion of verticalized, relevant project content and registered members.

15. The system of claim 11, wherein the electronically receiving of project information and candidate collaborator information is conducted through a website.

16. The system of claim 15, wherein the project information and candidate collaborator information is submitted to the website from member devices.

17. The system of claim 11, wherein the attributes of the project are stored in a project database and candidate collaborator information is stored in a collaborator database.

18. The system of claim 11, wherein the notifying communication comprises email messaging and/or text messaging.

19. The system of claim 15, wherein the imbedded communication link comprises an address of the website.

20. The system of claim 11, wherein the verticalized collaborative network system is configured to be project-centric to focus on processing of related project subject matter and interested collaborators.

21. A computer-readable medium for collaborative participation of a project within a verticalized collaborative network system, the medium have information recorded thereon which, when executed by a computer, causes the computer to perform the following:
electronically receive project information indicating details of the project and candidate collaborator information identifying potential participants corresponding to the project and their respective contact information, the project and candidate collaborator information provided by a verified collaborator of the verticalized collaborative network system;
process the received project and candidate collaborator information to respectively store attributes of the project and contact information;
process the attributes of the project and candidate collaborator information to generate a notifying communication to the potential participants, the notifying communication including a message notifying each of the potential participants of recognition relative to the project, inviting each of the potential participants to register as members of the verticalized collaborative network system, and providing an imbedded communication link for response to the invitations; and
electronically transmit the notifying communication to each of the potential participants in accordance with their respectively stored contact information.

22. The computer-readable medium of claim 21, further comprising that, in response to actuation of the imbedded communication link by the potential participants, the verticalized collaborative network system presents the potential participants with credential requests and, upon valid entry of the credential requests, the verticalized collaborative network system verifies and establishes the potential participants as registered members enabling access to review, verify, and revise the attributes of the project and opportunities to withdraw from participation of the project.

23. The computer-readable medium of claim 21, wherein the notifying communication includes reward and/or recognition information to potential participants.

24. The computer-readable medium of claim 23, wherein the eliciting of collaborative participation iteratively leads to a viral expansion of verticalized, relevant project content and registered members.

25. The computer-readable medium of claim 21, wherein the electronically receiving of project information and candidate collaborator information is conducted through a website.

26. The computer-readable medium of claim 25, wherein the project information and candidate collaborator information is submitted to the website from member devices.

27. The computer-readable medium of claim 21, wherein the attributes of the project are stored in a project database and candidate collaborator information is stored in a collaborator database.

28. The computer-readable medium of claim 21, wherein the notifying communication comprises email messaging and/or text messaging.

29. The computer-readable medium of claim 25, wherein the imbedded communication link comprises an address of the website.

30. The computer-readable medium of claim 21, wherein the verticalized collaborative network system is configured to be project-centric to focus on processing of related project subject matter and interested collaborators.

31. A computer-implemented method for collaborative participation of a project within a verticalized network system, the method being implemented by the network system having one or more physical processors programmed with computer program instructions that, when executed by the one or more physical processors, cause the network system to perform the method, the method comprising:
electronically receiving project information and information regarding potential collaborators of the project;
processing the received project and potential collaborator information to respectively store attributes of the project and potential collaborators;
processing the attributes of the project and potential collaborator information to generate a notifying communication to the potential collaborators, the notifying communication including a message notifying each of the potential collaborators of recognition relative to the project, and inviting each of the potential collaborators that are unregistered to register with the network system; and
electronically transmitting the notifying communication to each of the potential collaborators in accordance with their respectively stored contact information,
wherein, in response, the network system presents the potential collaborators with credential requests and, upon valid entry of the credential requests, the network system establishes the unregistered collaborators as registered collaborators, and
potential collaborators are verified as collaborators of the project and are provided with access, viewing, and revision rights to the project attributes.

32. A computer-implemented method for collaborative participation of a project within a verticalized network system, the method being implemented by the network system having one or more physical processors programmed with computer program instructions that, when executed by the one or more physical processors, cause the verticalized network system to perform the method, the method comprising:
electronically receiving project information that includes verified collaborators and potential participants of the project;
processing the received project and collaborator and potential participant information to respectively store attributes of the project, collaborators, and potential participants;
processing the attributes of the project and collaborator information to generate a notifying communication to the potential participants, the notifying communication including a message notifying each of the potential participants of recognition relative to the project, and inviting each of the potential participants to register with the network system; and
electronically transmitting the notifying communication to each of the potential participants in accordance with their respectively stored contact information,
wherein, in response, the network system presents the participants with credential requests and, upon valid entry of the credential requests, the network system establishes the unregistered participants as registered participants, and
the registered participants are verified as collaborators of the project and are provided with access, viewing, and revision rights to the project attributes.

33. A computer-implemented method for collaborative participation of a project within a verticalized network system, the method being implemented by the network system having one or more physical processors programmed with computer program instructions that, when executed by the one or more physical processors, cause the verticalized network system to perform the method, the method comprising:
electronically receiving project information that includes unverified collaborators of the project;
processing the received project and collaborator information to respectively store attributes of the project and collaborators;
processing the attributes of the project and unverified collaborator information to generate a notifying communication to the unverified collaborators, the notifying communication including a message notifying each of the unverified collaborators of recognition relative to the project, and inviting each of the unverified collaborators to register with the network system; and
electronically transmitting the notifying communication to each of the unverified collaborators in accordance with their respectively stored contact information,
wherein, in response, the network system presents the unverified collaborators with credential requests and, upon valid entry of the credential requests, the network system establishes the unverified collaborators as registered unverified collaborators,
the unverified collaborators are requested to verify themselves as collaborators of the project, and
the verified collaborators of the project are provided with access, viewing, and revision rights to the project attributes.

34. A computer-implemented method for collaborative participation of a project within a verticalized network system, the method being implemented by the network system having one or more physical processors programmed with computer program instructions that, when executed by the one or more physical processors, cause the network system to perform the method, the method comprising:
electronically receiving project information that includes unverified collaborators of the project;
processing the received project and collaborator information to respectively store attributes of the project and collaborators;
processing the attributes of the project and unverified collaborator information to generate a notifying communication to the unverified collaborators, the notifying communication including a message notifying each of the unverified collaborators of recognition relative to the project, and inviting each of the unverified collaborators to register with the network system; and
electronically transmitting the notifying communication to each of the unverified collaborators in accordance with their respectively stored contact information,
wherein, in response, the collaborative network system presents the unverified collaborators and, upon valid entry of the credential requests, the network system establishes the unverified collaborators as registered unverified collaborators,
the verified collaborators are requested to verify the registered unverified collaborators of the project, and
the verified collaborators of the project are provided with access, viewing, and revision rights to the project attributes.
